(19) United States
(12) Patent Application Publication
(10) Pub. No.: US 2026/0104773 A1
(43) Pub. Date: Apr. 16, 2026

(54) Classifying a Proximity Input

(71) Applicant: Cirque Corporation, Sandy, UT (US)

(72) Inventor: Daniel Ferguson, Herriman, UT (US)

(73) Assignee: Cirque Corporation, Sandy, UT (US)

(21) Appl. No.: 19/420,392

(22) Filed: Dec. 15, 2025

Related U.S. Application Data
(63) Continuation-in-part of application No. 18/947,662, filed on Nov. 14, 2024, now Pat. No. 12,524,119.
Application No. 18/947,662 is a continuation-in-part of application No. 18/883,887, filed on Sep. 12, 2024, now Pat. No. 12,443,314.
Application No. 18/883,887 is a continuation-in-part of application No. 18/809,924, filed on Aug. 20, 2024, now Pat. No. 12,422,960.

(51) Int. Cl. G06F 3/041

(52) U.S. Cl. CPC G06F 3/0418; G06F 2203/04104; G06F 2203/04108

(57) ABSTRACT

A capacitance module may include a set of electrodes, a controller in communication with the set of electrodes, and memory in communication with the controller. The memory may include programmed instructions that cause the controller, when executed, to store a touch attribute of a touch capacitance measurement associated with a touch input, store a proximity attribute of a proximity capacitance measurement associated with a proximity input, and update the proximity attribute based on an unprompted capacitance measurement.

### CROSS REFERNECE TO RELATED APPLICATIONS

This application is a continuation-in-part of U.S. Patent Application Serial No. 18/947,662 titled User Identification with a Capacitance Module and filed on November 14, 2024. U.S. Patent Application Serial No. 18/947,662 is a continuation-in-part of U.S. Patent Application Serial No. 18/883,887 titled Response to a Typing Input and filed on September 12, 2024. U.S. Patent Application Serial No. 18/883,887 is a continuation-in-part of U.S. Patent Application Serial No. 18/809,924 titled Determining an Unprompted Input filed on August 20, 2024. U.S. Patent Application Serial No. 18/809,924 is herein incorporated by reference for all that it discloses.

### FIELD OF THE DISCLOSURE

This disclosure relates generally to systems and methods for enhancing input accuracy in capacitive touch devices. In particular, this disclosure relates to systems and methods for distinguishing between touch and proximity inputs.

### BACKGROUND

A capacitance sensor is often incorporated into laptops to provide a mechanism for giving inputs to the device. Some capacitance sensors may be configured to detect touch inputs, where an input object makes physical contact with a reference surface, such as a touchpad, as well as proximity inputs, where an input object is brought close to the capacitance sensor without making physical contact. Such capacitance sensors may differentiate between touch inputs and proximity inputs using specialized hardware or software.

An example of a capacitance sensor capable of touch and proximity sensing is disclosed in U.S. Patent No. 8,902,191 issued to David Hoch. This reference discloses a method and apparatus for operating an input device having an array of capacitive sensor electrodes and a proximity sensor electrode. The input device includes a processing system communicatively coupled to the array of capacitive sensor electrodes and the proximity sensor electrode and configured to operate in an input mode and a proximity mode. When operating in the input mode, the processing system scans the array of capacitive sensor electrodes to detect input from an object in an active region of the input device. When operating in the proximity mode, the processing system drives a sensing signal on at least one sensor electrode of the array of capacitive sensor electrodes and receives a resulting signal on at least one sensor electrode of the array of capacitive sensor electrodes and receives a resulting signal from the proximity sensor electrode. Based on the resulting signal, the processing system generates an indication of an object present in a second sensing region from the resulting signal.

Another example of a capacitive sensor capable of touch and proximity sensing is disclosed in U.S. Patent No. 9,236,861 issued to Jenn Woei Soo, et al. This reference discloses a capacitive proximity sensor circuit capable of distinguishing between instances of detected user proximity. The sensor includes one or more guard electrodes, a first sensor, and a second sensor. The capacitive proximity sensor is installed in a device such that a first sensor faces a first component of the device, and the second sensor faces a second component of the device. The first and second sensors measure a capacitance to detect proximity of a user relative to the respective sensor. The guard electrode is provided to mitigate stray capacitance to reduce error in the capacitance measurement obtained by the first and second sensors.

An example of a system for estimating the location of an input object is disclosed in U.S. Patent Application No. 2018/0032170 issued to Karimulla Shaik, et al. This reference discloses a method and capacitive touch panel. The method. Includes receiving, by a sensing circuit, raw data for detecting a touch object in a proximity of a capacitive touch panel, where the raw data includes a difference of a mutual capacitance value and a self-capacitance value at each of touch nodes of the capacitive touch panel; processing, by a touch sensing controller, the received raw data to derive digitized capacitance data; classifying, by the touch sensing controller, the digitized capacitance data; and estimating, by the touch sensing controller, at least one of a location of the touch object on the capacitive touch panel and a distance. Of the touch object from the capacitive touch panel within the proximity using the classified capacitance data.

Each of these references are herein incorporated by reference for all that they disclose.

### SUMMARY

In one embodiment, a capacitance module may include a set of electrodes, a controller in communication with the set of electrodes, and memory in communication with the controller. The memory may include programmed instructions that cause the controller, when executed, to store a touch attribute of a touch capacitance measurement associated with a touch input, store a proximity attribute of a proximity capacitance measurement associated with a proximity input, and update the proximity attribute based on an unprompted capacitance measurement.

The programmed instructions may cause the controller to prompt a touch input.

The programmed instructions may cause the controller to prompt a proximity input.

The programmed instructions may cause the controller to store a noise attribute associated with at least one of the touch input and proximity input.

The programmed instructions may cause the controller to prompt a noise input and store a noise attribute of a capacitance measurement associated with the noise input.

The proximity input may be associated with a single finger gesture.

The proximity input may be associated with a two-finger gesture.

The proximity input may be associated with a three-finger gesture.

The proximity attribute may include at least one of a minimum detectable proximity distance, a proximity slope, and a proximity decay rate.

The programmed instructions may cause the controller to classify an unprompted input by consulting at least one of the stored touch attribute and proximity attribute.

Classifying the unprompted input may include classifying the unprompted input as a touch input.

Classifying the unprompted input may include classifying the unprompted input as a proximity input.

Classifying the unprompted input may include classifying the unprompted input as a one finger proximity input.

Classifying the unprompted input may include classifying the unprompted input as a two-finger proximity input.

Classifying the unprompted input may include classifying the unprompted input as a three-finger proximity input.

The programmed instructions may cause the controller to create the touch attribute using a touch machine learning model, train the touch machine learning model with multiple

touch inputs, create the proximity attribute using a proximity machine learning model, and train the proximity machine learning model with multiple proximity inputs.

Training the touch machine learning model and proximity machine learning model may include unsupervised learning.

In another embodiment, a computer-program product for determining a proximity input on a capacitance module may include a non-transitory computer-readable medium storing instructions executable by a controller to store a touch attribute of a touch capacitance measurement associated with a touch input, store a proximity attribute of a proximity capacitance measurement associated with a proximity input, and classify an unprompted capacitance input by consulting at least one of the stored touch attribute and stored proximity attribute.

The medium may store further instructions executable by a controller to prompt a touch input and prompt a proximity input.

The medium may store further instructions executable by a controller to train a machine learning model with at least the touch attribute, and train a. proximity machine learning model with at least the proximity attribute, wherein classifying an unprompted capacitance input includes consulting the output of the touch machine learning model and the proximity machine learning model.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a touch pad in accordance with the disclosure.

FIG. 4 depicts an example of a touch screen in accordance with the disclosure.

FIG. 5 depicts an example of an input surface in accordance with the disclosure.

FIG. 6 depicts an example of an input surface in accordance with the disclosure.

FIG. 7 depicts an example of an arrangement of pressure sensors in accordance with the disclosure.

FIG. 8 depicts an example of an arrangement of pressure sensors in accordance with the disclosure.

FIG. 9 depicts an example of an arrangement of pressure sensors in accordance with the disclosure.

FIG. 10 depicts an example of an arrangement of pressure sensors in accordance with the disclosure.

FIG. 11 depicts an example of prompting a touch input in accordance with the disclosure.

FIG. 12 depicts an example of prompting a proximity input in accordance with the disclosure.

FIG. 13 depicts an example of prompting a noise input in accordance with the disclosure.

FIG. 14a depicts an example of a touch input in accordance with the disclosure.

FIG. 14b depicts an example of a touch input in accordance with the disclosure.

FIG. 15a depicts an example of a proximity input in accordance with the disclosure.

FIG. 15b depicts an example of a capacitance graph in accordance with the disclosure.

FIG. 16 depicts an example of a proximity input in accordance with the disclosure.

FIG. 17 depicts an example of a proximity input in accordance with the disclosure.

FIG. 18 depicts an example of a proximity input in accordance with the disclosure.

FIG. 19 depicts an example of a proximity input in accordance with the disclosure.

FIG. 20 depicts an example of a proximity input in accordance with the disclosure.

FIG. 21 depicts an example of a proximity input in accordance with the disclosure.

FIG. 22 depicts an example of a proximity input in accordance with the disclosure.

FIG. 23a depicts an example of an electronic device in accordance with the disclosure.

FIG. 23b depicts an example of an electronic device in accordance with the disclosure.

FIG. 24 depicts an example of a method for classifying a capacitance input in accordance with the disclosure.

FIG. 25 depicts an example of a method for classifying a capacitance input in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION OF THE INVENTION

This description provides examples, and is not intended to limit the scope, applicability, or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object’s length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that can be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a computer mouse, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen.” The capacitance module may be incorporated into an electronic device.

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

In some cases, the capacitance module is located within a housing. The capacitance module may be underneath the housing and capable of detecting objects outside of the housing. In examples, where the capacitance module can detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

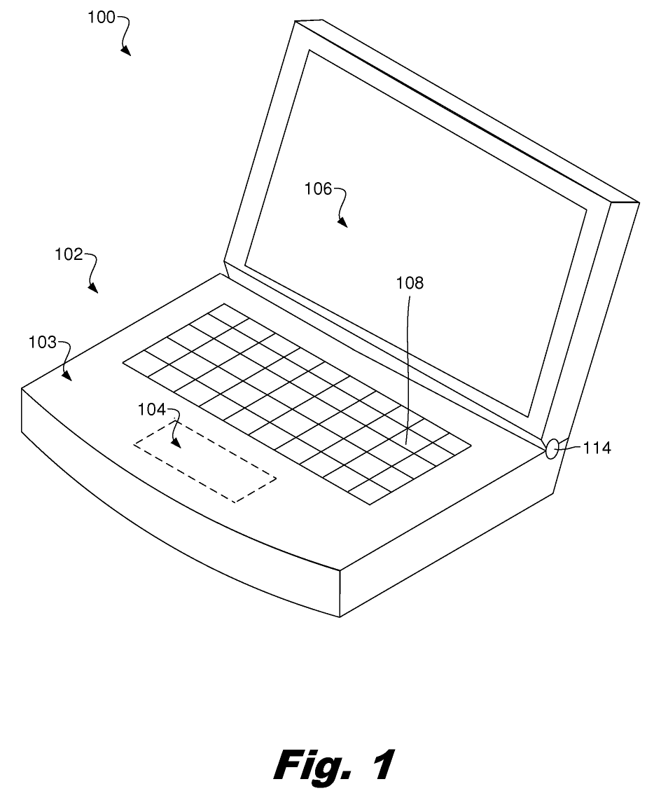

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device’s display and give a command through the touch pad 104 to select that object. For example, the user may provide instructions to select the object by tapping the surface of the touch pad 104 one or more times.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard’s surface where the user’s palms may rest while typing. The capacitance module may include a substrate, such as a printed circuit board or another type of substrate. One of the layers of the capacitance module may include a sensor layer that includes a first set of electrodes oriented in a first direction and a second layer of electrodes oriented in a second direction that is transverse the first direction. These electrodes may be spaced apart and/or electrically isolated from each other. The electrical isolation may be accomplished by deposited at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approach the intersections between the electrodes, the capacitance between the electrodes may change. This change in capacitance and the associated location of the object in relation to the capacitance module may be calculated to determine where the user is touching or hovering the object within the detection range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user’s finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

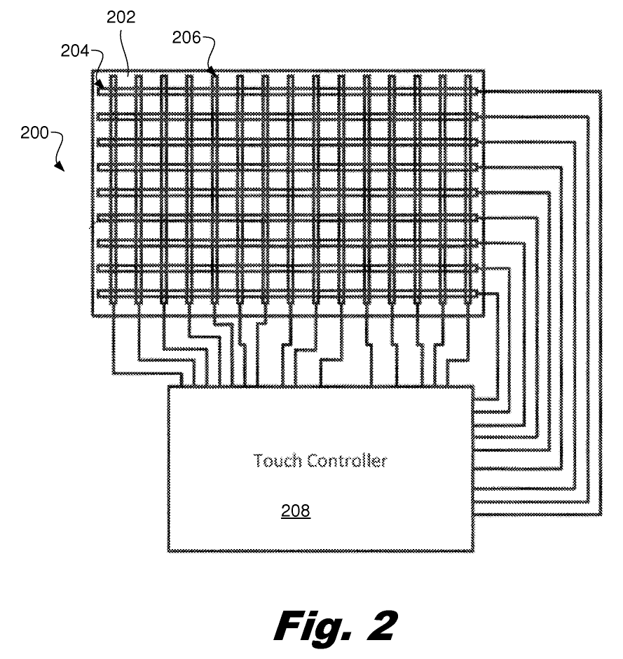

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 208 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

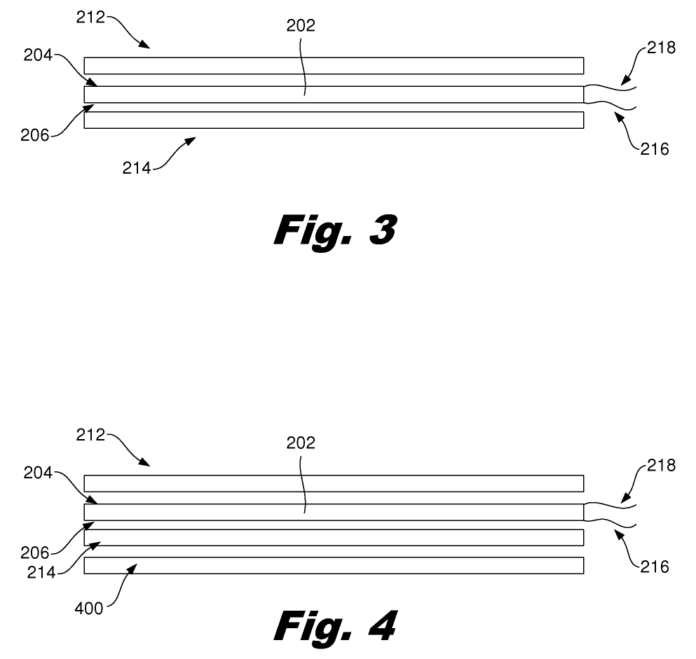

In some cases, the capacitance controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are foreseen such as a self-capacitance mode where the electrodes are driven and sensed simultaneously. Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also foreseen.

In some cases, no fixed reference point is used for measurements. The touch controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user’s finger or stylus approach the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is solid piece of material that is electrically conductive. In other cases, the shield has a substrate and an electrically conductive material disposed on at least one substrate. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the touch controller 208 to the appropriate set of electrodes. The voltage applied to the sense electrode through the electric fields generated from the transmit electrode may be detected through the electrical connection 218 from the sense electrodes to the touch controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

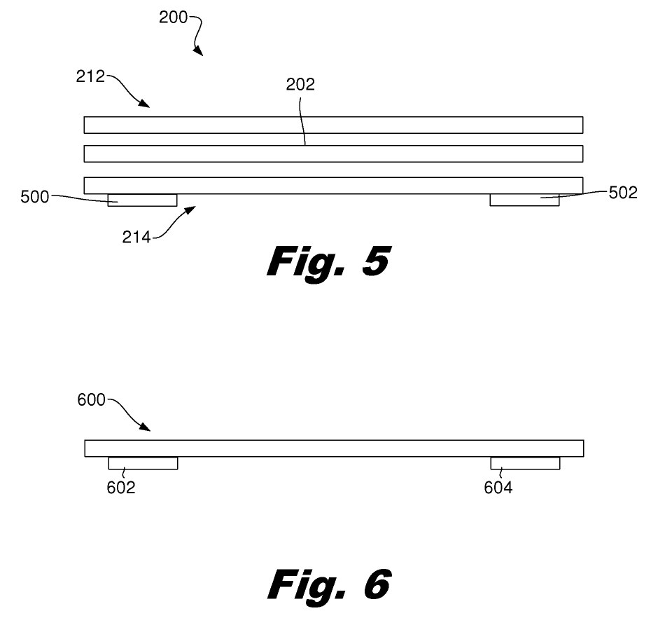

FIG. 5 depicts an example of a cross section of a capacitance module 200 where the substrate 202 may be located between a capacitance reference surface 212 and a shield 214. In this example, a first haptic actuator 500 and a second haptic actuator 502 are incorporated into the capacitance module 200. As depicted in this example, the haptic actuators 500, 502 may be disposed adjacent to an underside of the shield 214. But, in other examples, the haptic actuators may be positioned at any appropriate location, including, but not limited to, adjacent the underside of the capacitance reference surface 212, adjacent the underside of the shield, adjacent the underside of the substrate 202, on another surface, another location, or combinations thereof. In some cases, the parts of the haptic actuator may be spread across multiple layers of the module. In examples where the haptic actuators 500, 502 are positioned under the substrate 202.

In some examples, the haptic actuator may also be a pressure sensor. In such an example, pressure applied to the capacitance reference surface 212 may be transmitted through the capacitance reference surface 212 exerting a pressure on the substrate 202, which in turn applies a pressure to at least one of the haptic actuators 500, 502. In examples where the haptic actuators are positioned adjacent to the shield, the pressure applied to the input surface may be transmitted to the shield, which in turn applies the pressure to the haptic actuators. This pressure may be measured by the haptic actuators 500, 502 to determine the value of the pressure.

In the depicted example, the first haptic actuator 500 is spaced apart from the second haptic actuator 502 at a distance along a length, width, and/or another dimension of the capacitance reference surface 212, which may allow the first haptic actuator 500 and the second haptic actuator 502 to detect different levels of pressure depending on the location where the pressure input is made on the capacitance reference surface 212. In some cases, those haptic actuators that are closer to the location where the pressure input is made can detect a greater pressure force than the haptic actuator that is located farther away. The differing pressure values may help determine where the pressure input is made.

While this example has been describe with reference to the haptic actuators having the ability to measure pressure, in other examples, the haptic actuators are not capable of measuring pressure or may not be used to measure pressure. In some cases, the haptic actuators may be capable of measuring pressure, but the module may include at least one mechanism that may be used to measure pressure. In some cases, the module may include at least one dedicated pressure sensor in addition to the haptic actuator(s).

Any appropriate type of pressure sensor may be used in accordance with the principles described herein. For example, a non-exhaustive list of suitable pressure sensors includes, but is not limited to, piezoelectric sensors, magnetostrictive sensors, potentiometric pressure sensors, inductive pressure sensors, capacitive pressure sensors, strain gauge pressure sensors, variable reluctance pressure sensors, other types of pressure sensors, or combinations thereof.

In some examples, the pressure sensor is a piezoelectric device that may be used as both a pressure sensor and as a haptic device. When the piezoelectric material is compressed due to the application of pressure through the capacitance reference surface, the piezoelectric material may produce an electric signal with can be detected by a controller. In some cases, the controller may produce an electric signal that is sent to the piezoelectric material to cause the piezoelectric material to expand, contract, and/or vibrate. The vibrations from the piezoelectric material may cause the capacitance reference surface to vibrate. This vibration may communicate a haptic signal to the user. However, in some examples, the pressure sensors are not configured to provide a haptic signal.

FIG. 6 depicts an example of a reference surface 600. In this example, a first haptic actuator 602 and a second haptic actuator 604 are located adjacent to the reference surface 600. In this example, the first haptic actuator 602 and the second haptic actuator 604 are not incorporated into a stack having a capacitance sensor.

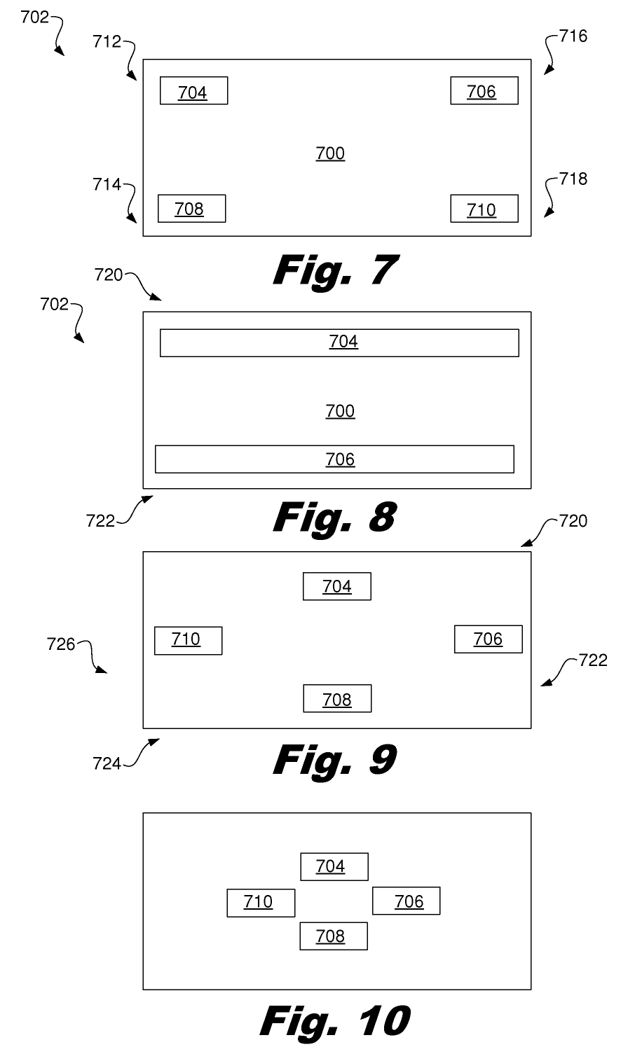

FIGS. 7-10 depict examples of haptic actuators depicted on an underside 700 of a reference surface 702. In the example of FIG. 7, the reference surface 702 has a rectangular shape and haptic actuators 704, 706, 708, 710 are positioned in each of the corners 712, 714, 716, 718. In the example of FIG. 8, just a first haptic actuator 704 is depicted on a first side 720, and a second haptic actuator 706 is depicted on a second side 722 of the input surface 702. In the example of FIG. 9, the haptic actuators 704, 706, 708, 710 are depicted in the center of the first side 720, the second side 722, the third side 724, and the fourth side 726. In the examples of FIG. 10, the haptic actuators 704, 706, 708, 710 are depicted towards the center of the input surface and away from the edges and corners of the input surface 702.

While the examples in FIGS. 7-10 are described with reference to a specific number of haptic actuators, any appropriate number of haptic actuators may be disposed adjacent to the input surface. For example, the number of haptic actuators may include one haptic actuator or multiple haptic actuators. While the examples depicted above are described with reference to specific patterns and locations for the haptic actuators, other arrangements are contemplated including, but not limited to, symmetric distribution of sensors, an asymmetric distribution of sensors, other distributions and patterns of sensors, or combinations thereof.

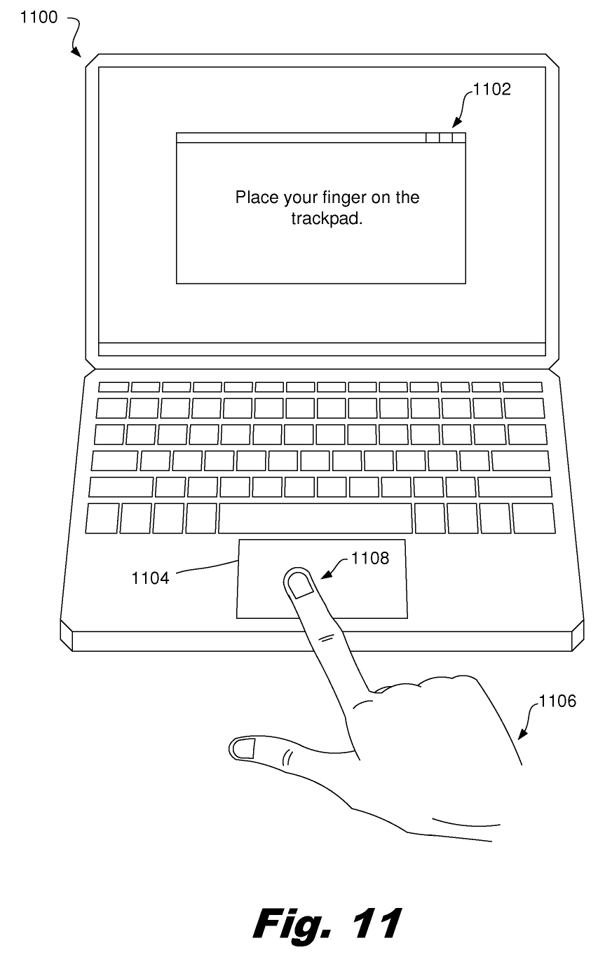

FIG. 11 depicts an example of an electronic device 1100 in accordance with the disclosure. In this example, the electronic device 1100 is a laptop. The electronic device 1100 includes an input device 1104 that includes a capacitance module. A user 1106 may provide a touch input 1108 on the input device 1104. In some examples, the touch input 1108 may be provided in response to an input prompt 1102 displayed with the electronic device 1100. In other examples, the touch input 1108 may be provided unprompted.

In this example, the input prompt 1102 is communicated to the user 1106 by displaying the prompt on the display of the electronic device 1100. In other examples, an input prompt may be communicated differently. For example, an input prompt may be communicated to a user by audio announcement through a speaker or audio interface, by haptic feedback through vibrations and/or tactile sensations, by using lights or LED signals, by text message to a connected device, by some other method of communication, or combinations thereof.

Upon receiving the input prompt 1102, the user 1106 may provide the user input 1108 to the input device 1104. The user input 1108 may correspond to the prompt 1102. In this example, the user input 1108 is a touch input corresponding to the input prompt 1102 to place a finger on the trackpad. In other examples, a user may be prompted to provide a different input. In some examples, a user may be prompted to provide a touch input with multiple fingers. In other examples, a user may be prompted to provide a proximity input wherein the user may place one or more fingers above the trackpad without making physical contact with the trackpad. In yet other examples, a user may be prompted to provide a noise input where they remove their fingers from the trackpad entirely while a measurement of the capacitance module’s baseline noise is taken.

As the user input 1108 is provided, the capacitance module may take at least one capacitance measurement of the input. In some examples, multiple measurements may be taken. In some cases, the measurements may be taken with self-capacitance measurements and/or mutual capacitance measurements.

The capacitance measurements may include, but are not limited to, an input length, input width, input surface area, a centroid position, a signal rise time, a signal decay time, a peak signal strength, a signal-to-noise ratio, a rate of change in capacitance over time, a rate of change in capacitance over distance, a detected contact boundary, a distribution profile, or another type of measurement associated with the input. The measurements of the input 1108 may include a duration element, such as the duration of contact or the duration of proximity between the input and the reference surface of the input device 1104.

The measurement corresponding to the user input 1108 may be processed and stored in memory resources. These measurement may form a reference dataset for the corresponding input 1108. After the prompt communication, user input, and measurement recording, a calibration process may repeat these tasks to collect measurements and form reference datasets for different types of user inputs. For example, a user may first be prompted to provide a touch input and then be prompted to provide a proximity input.

A touch input may include touching a reference surface of the input device 1104 with one or more fingers. In some examples, providing a touch input may include performing a gesture, such as a swipe or pinch. In response to detecting a touch input, the input device 1104 may record a capacitance signal strength, multiple capacitance signal strengths at select locations corresponding to a finger shape, finger length, finger width, multiple finger widths, a finger shape, a surface area, a finger size, another dimension of the finger shape, another attribute associated with the measured signals from the finger input, or combinations thereof.

A proximity input may include hovering over a reference surface of the input device 1104. For example, a proximity finger input may include hovering a finger over the reference surface of the input device 1104 without touching the input device. A proximity prompt may request that the user swipe his or her hand over the reference surface, make a single-finger gesture, make a multi-finger gesture, make a single-handed gesture, make a multi-handed gesture, make another type of motion, or combinations thereof.

In response to detecting a proximity input, the input device 1104 may record a capacitance signal strength, multiple capacitance signal strengths at select locations corresponding to a proximate input shape, a proximate shape length, a proximate shape width, multiple widths along the length of the proximate shape, a proximate shape size, another attribute associated with the measured signals from the proximate input, or combinations thereof.

In some cases, the raw data obtained from the various inputs may be stored as input attributes. In other examples, input attributes may include processed data. In some examples, the processed attributes may include average lengths, median lengths, maximum lengths, minimum lengths, lengths within a first standard deviation, average widths, median widths, maximum widths, minimum widths, widths within a first standard deviation, average surface areas, median surface areas, maximum surface areas, minimum surface areas, surface areas within a first standard deviation, average capacitance signal strengths, median capacitance signal strengths, maximum capacitance signal strengths, minimum capacitance signal strengths, capacitance signal strengths within a first standard deviation, average sizes, median sizes, maximum sizes, minimum sizes, sizes within a first standard deviation, other processed attributes, or combinations thereof. In some cases, both raw and processed attributes are stored and/or used to compare against unprompted user inputs.

The attributes collected during calibration may be used to train one or more machine learning models configured to classify subsequent inputs received with the input device 1104. In some examples, the machine learning models may be trained once during an initial calibration phase. In other examples, the machine learning models may be continuously updated during operation to account for changes in user behavior, environmental conditions, or device noise characteristics. In some examples, the machine learning models may operate using supervised learning with labeled input types. In other examples, the machine learning models may use unsupervised or semi-supervised learning to detect clusters, patterns, or other relationships between stored attributes. The machine learning models may generate updated touch attributes, proximity attributes, and noise attributes, and may refine internal classification boundaries based on ongoing comparisons between new capacitance measurements and the stored reference datasets.

During operation of the electronic device 1100, the input device 1104 may classify capacitance inputs by comparing the new capacitance measurements with the reference datasets stored in its memory. The comparison may involve evaluating similarities and differences between the new measurements and the stored attributes. In some examples, the input device 1104 may use this analysis to classify an unprompted input as a touch input or a proximity input when at least one of the attributes of the unprompted input matches or is at least similar to one of the stored touch or proximity attributes. In other examples, classifying an unprompted input may include providing the unprompted input to a machine learning model classifier trained on user-specific input attributes, which may output a classification label for the provided input, a confidence level, a probability distribution across multiple classifications, or combinations thereof.

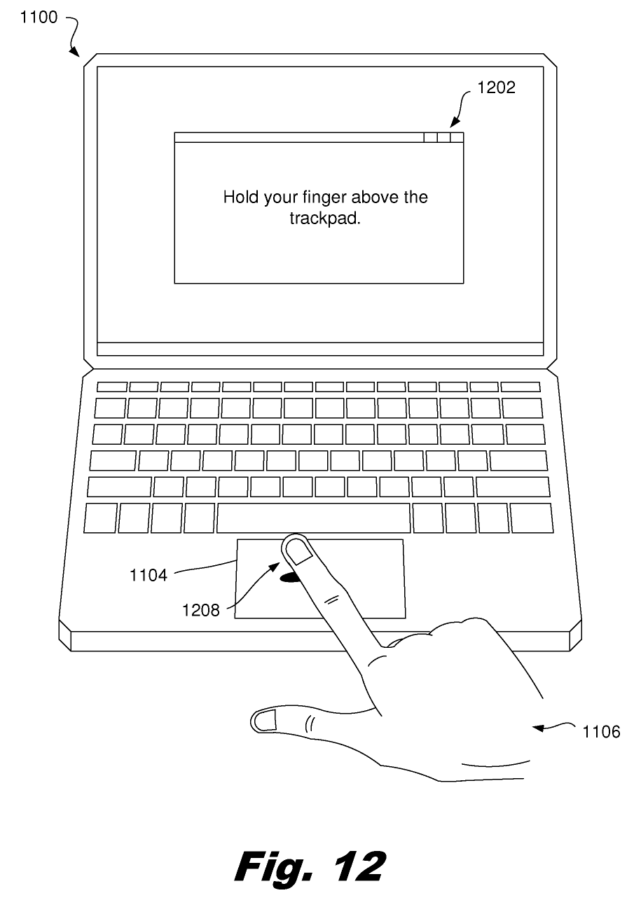

FIG. 12 depicts an example of the electronic device 1100 outputting an input prompt 1202 requesting that the user 1106 provide a proximity input 1208. In this example, the input prompt 1202 instructs the user 1106 to hold a finger above the input device 1104 without making physical contact. A proximity input may include positioning one or more fingers, a thumb, a palm, a stylus, or another input object at a distance above the reference surface of the input device 1104. In some examples, a proximity input may include performing a gesture, such as a swipe or pinch, above the reference surface of the input device 1104. As the proximity input 1208 is provided, the capacitance module may measure changes in capacitance corresponding to the distance, shape, and movement of the object above the reference surface. Recording proximity inputs during calibration may allow the input device 1104 to generate proximity attributes, such as proximity signal strengths or decay characteristics, that may be used to classify unprompted inputs as proximity inputs during operation of the electronic device 1100. Training a machine learning classifier with the proximity attributes may allow the classifier to distinguish subsequent proximity inputs from touch inputs, even when the respective signal patterns for each partially overlap.

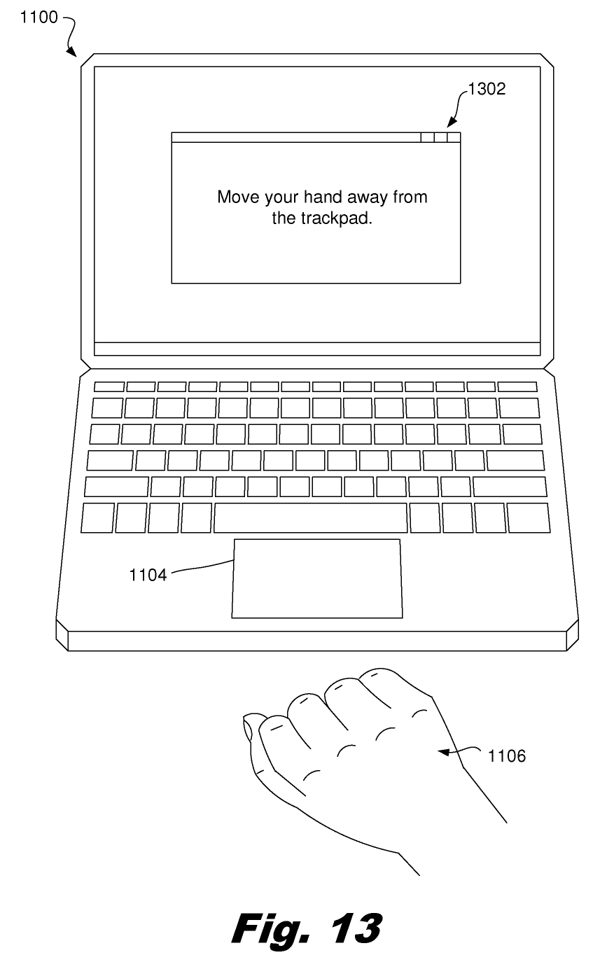

FIG. 13 depicts an example of the electronic device 1100 outputting an input prompt 1302 requesting that the user 1106 provide a noise input. In this example, the input prompt 1302 instructs the user 1106 to move his or her hand away from the input device 1104 so that the capacitance module may record baseline capacitance measurements in the absence of intentional user interaction. A noise input may include removing the user’s fingers, hands, styluses, or other input objects from the reference surface and surrounding region of the input device 1104 such that the measured capacitance primarily reflects environmental noise, device-level noise, and background signal variation. Recording noise inputs during calibration may allow the input device 1104 to generate noise attributes, such as noise amplitudes, drift characteristics, and fluctuation profiles. These noise attributes may improve input classification by providing a reference for distinguishing true touch and proximity input signal from transient disturbances or low-magnitude fluctuations that might otherwise be misinterpreted as intentional inputs.

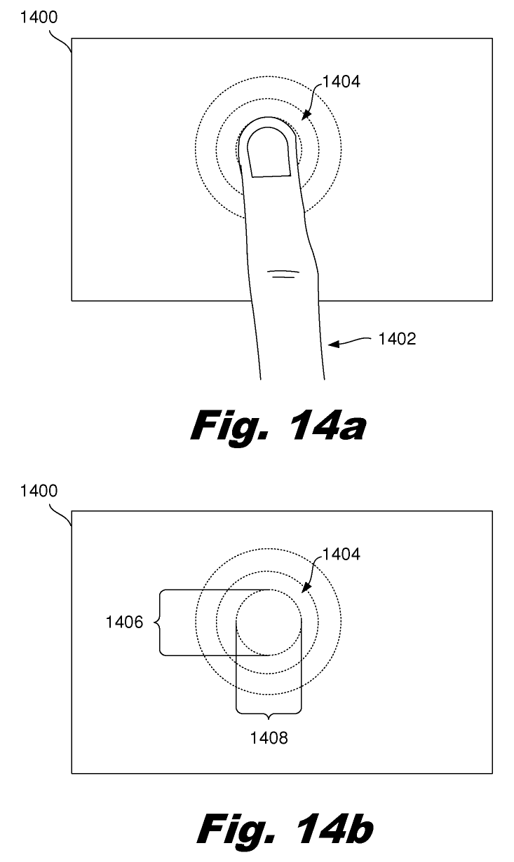

FIGS. 14a and 14b depict examples of a touch input 1404 in accordance with the disclosure. In the example depicted in FIG. 14a, a user 1402 provides the touch input 1404 on a surface of a capacitance module 1400. As the user 1402 touches the capacitance module 1400, the module may record capacitance measurements corresponding to the touch input 1404. FIG. 14b depicts capacitance measurements which may correspond to touch inputs. The capacitance module 1400 may measure the length 1406 of the user input 1404 and/or the width 1408 of the input. The length 1406 and the width 1408 of the user input 1404 may be used to form a reference dataset for the user input, allowing the capacitance module 1400 to differentiate between user inputs of different types. In some examples, the length 1406 and width 1508 may be processed to calculate a surface area measurement on the reference surface for the capacitance module 1400 to differentiate between user inputs of different types. In some examples, the length 1406 and width 1408 may be used to train a machine learning model for user input classification.

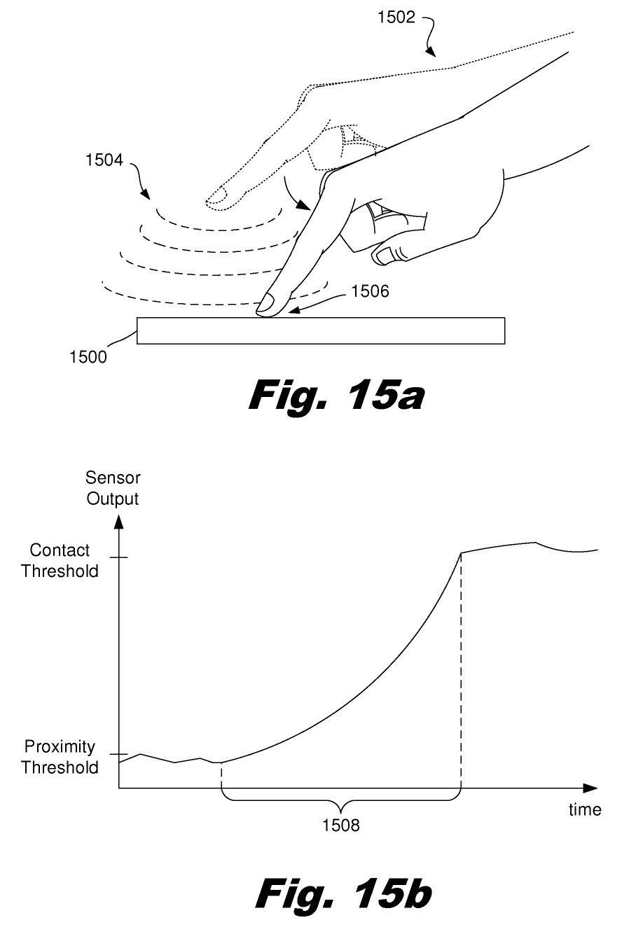

FIG. 15a depicts an example of a proximity input 1504 in accordance with the disclosure. In this example, a user 1502 may hold a finger above a surface of a capacitance module 1500 at a first time to provide a proximity input 1504. At a second time following the first time, the user 1502 may lower their finger until it makes physical contact with the capacitance module 1500, providing a touch input 1506. This sequence illustrates how different stages of an approaching input object generate distinguishable capacitance patterns that may be recorded and used to develop proximity and touch attributes for subsequent classification.

FIG. 15b depicts a sensor output graph of the capacitance module 1500 as the user inputs depicted in FIG. 15a are provided. In this example, the vertical axis represents the capacitance module’s capacitance signal strength, and the horizontal axis represents time. A proximity threshold and a contact threshold are depicted along the vertical axis. These threshold may be used to conceptually illustrate how proximity and touch signals differ, although in some examples the capacitance module may rely on machine-learned attributes rather than fixed thresholds for distinguishing between input types.

At the first time, as the user’s 1502 finger approaches the surface of the capacitance module 1500, the capacitance signal strength progressively increases, indicating a proximity input 1504 is approaching the trackpad. The proximity threshold is the minimum capacitance strength at which the capacitance module 1500 detects the presence of an input object. In some cases, the proximity threshold is the farthest distance that particular proximity gesture for that particular user maybe detect. For example, a multi-finger proximity gesture may be detectable at a distance that is farther away than a single finger gesture. Further, a user with bigger fingers may be detectable at a distance that is farther away than a user with relatively smaller fingers.

As the user’s finger continues to move closer to the capacitance module 1500, the capacitance strength may continue to increase. When the user’s 1502 finger makes physical contact with the reference surface at the second time, the capacitance strength may reach and surpass the contact threshold, thereby indicating the touch input 1506. While in this example the thresholds are depicted as discrete levels, in other examples, a capacitance module may instead evaluate these signal transitions using proximity and touch attributes generated with machine learning models.

The depicted area between the proximity threshold and contact threshold represents the proximity signal strength 1508. This depicted area may be used to distinguish between proximity inputs and physical touches. The capacitance signal strength corresponding to proximity inputs may be measured and stored to form a reference dataset of proximity attributes. In some cases, the system may classify the different types of proximity gestures (e.g., single finger, two-finger, three-finger, multi-finger, other type of gesture, etc.) as some different types of proximity gestures may have different touch threshold values, different proximity threshold values, different range values, or combinations thereof. These attributes may be used at a later time for classification between proximity and touch inputs. These attributes may also be used at a later time for classification between different types of proximity inputs. By comparing the capacitance signal strength of unprompted inputs to the capacitance signal strengths stored in the proximity attributes dataset, the capacitance module 1500 may determine when an input is a proximity input versus a touch input. In some examples, the proximity attributes may be used to train a machine learning classifier for input classification. Recording such proximity attributes may allow the classifier to learn the gradual curvature, rate of change, temporal shape, and other patterns present in FIG. 15b, enabling classification methods that do not depend on fixed proximity or contact thresholds. Measuring and storing proximity attributes for each user may enhance the. Accuracy of touch/proximity classification on a per-user basis, since individual users may naturally hold their fingers at different distances from the capacitance module 1500, have different dimensions, different densities, and/or different characteristics, and machine learning techniques may adapt to these personalized patterns over time.

In addition to the capacitance value strength, the area of the capacitance sensor with a change in capacitance may be mapped to determine the shape of the object providing the user input. Such a shape may be used to compare with finger gestures, different types of multi-finger gestures, and so forth to assist in distinguishing between touch and proximity inputs and/or distinguishing between different types of gestures inputs.

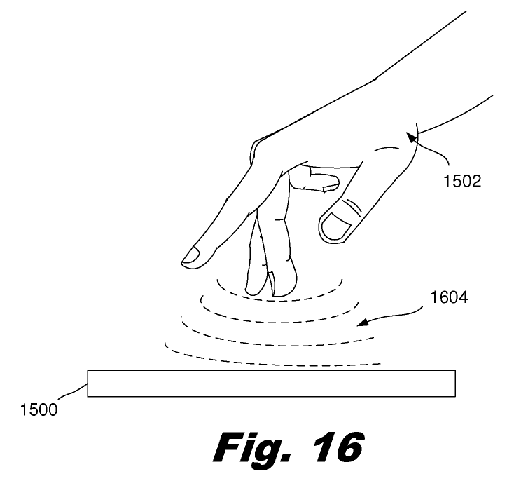

FIG. 16 depicts an example of a proximity input 1604 in accordance with the disclosure. In some examples, the user 1502 may provide a multi-finger proximity input to the capacitance module 1500. In this example, the multi-finger proximity input 1604 includes the user hovering both their middle and ring fingers above the surface of the capacitance module 1500. As the user 1502 provides the proximity input 1604, the capacitance module 1500 may record proximity attributes corresponding to the input for later use in input classification.

Measuring and storing attributes for multiple types of proximity inputs may offer advantages compared to recording proximity attributes for only a single type of proximity input. For example, different proximity configurations, such as one-finger, two-finger, or multi-finger inputs, may generate distinct capacitance distributions, spatial profiles, and signal-strength patterns across the electrodes of the capacitance module 1500. A multi-finger proximity input, such as the input 1604 may produce a wider or more complex electric-field disturbance than a single-finger proximity input, resulting in a different arrangement of measured capacitance values. Recording and storing these patterns during calibration may allow the capacitance module 1500 to distinguish between various unprompted proximity behaviors during later operation.

In some examples, the multi-finger proximity attributes may be used to train or refine a machine learning classifier configured to recognize characteristic proximity patterns associated with multiple fingertips, partial-hand hovers, or other multi-point inputs. Including these additional attribute sets may improve classifier robustness by enabling the system to correctly interpret a greater variety of real-world user behaviors, such as when a user unintentionally hovers multiple fingers near the capacitance module 1500 while intending to perform a single finger touch elsewhere. In this way, calibration data gathered from multi-finger proximity inputs may enhance the accuracy, adaptability, and reliability of proximity-versus-touch input classification.

In some examples, single and multi-finger proximity inputs may also correspond to proximity-based gestures performed above the capacitance module 1500. Such gestures may include, but are not limited to, one-finger swipes, two-finger swipes, three-fingers swipes, circular motions, proximity pinches, proximity spreads, or other multi-finger motions executed without making physical contact with the reference surface. Each gesture may produce a characteristic temporal pattern of capacitance changes, such as a shifting centroid, varying signal gradient, or evolving multi-point distribution that differs from static hover inputs. Recording these proximity-gesture attributes during calibration may enable the system to recognize unprompted proximity gestures during later operation, support gesture-based controls without requiring touch input, reduce false classifications of intentional gestures as noise or accidental hovers, and enhance the accuracy of machine-learning models trained to classify proximity inputs.

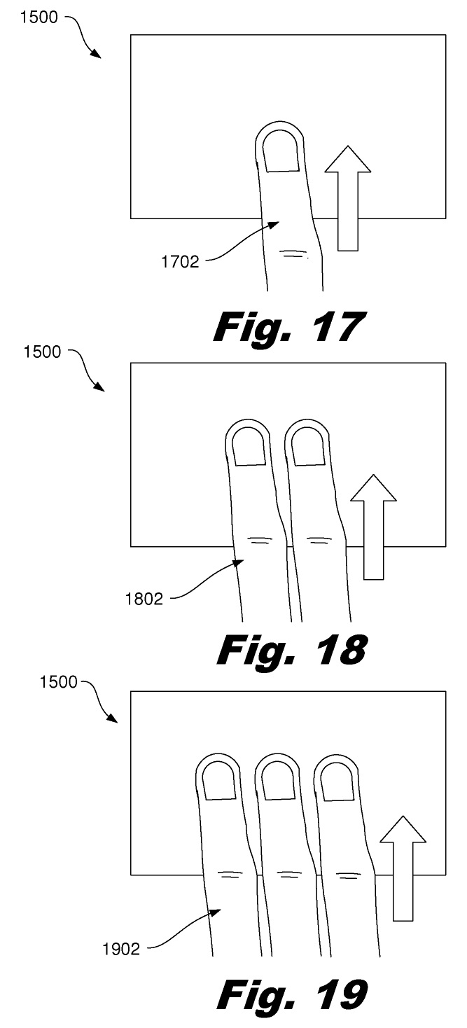

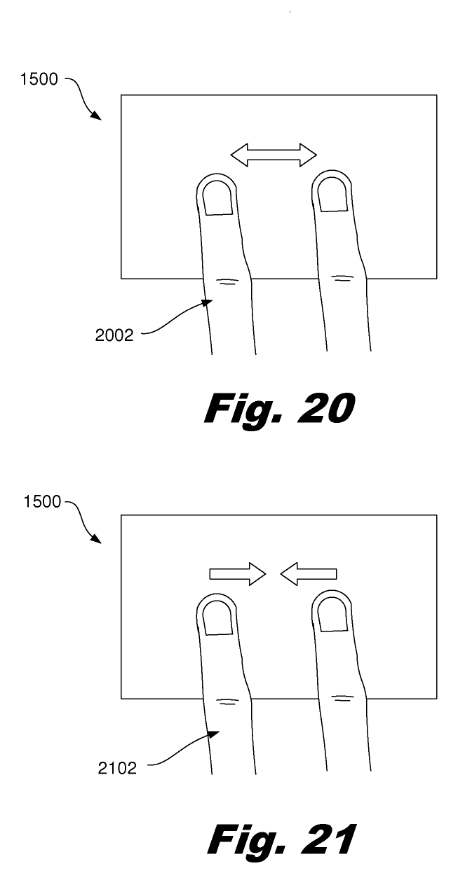

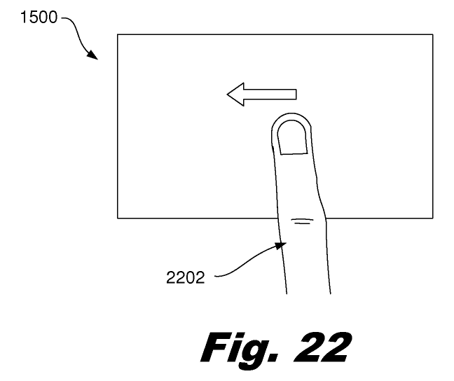

FIGS. 17-22 depict various examples of proximity inputs that may be performed during a calibration process to generate proximity attributes. Each of the various proximity inputs may be performed above the reference surface of the capacitance module 1500. In FIG. 17, a hover-in gesture 1702 with a single finger is performed. In FIG. 18, a two-finger hover-in gesture 1802 is performed. In FIG. 19, a three-finger hover-in gesture 1902 is performed. In FIG. 20, a two-finger spread 2002 wherein the user spaces one finger from another is performed. In FIG. 21, a two-finger pinch 22102 wherein the user brings two fingers together is performed. In FIG. 22, a single finger lengthwise swipe 2202 is performed. In addition to the gestures depicted in these examples, other multi-finger and single finger proximity inputs may be used to generate proximity attributes for input classification.

While the examples above depict specific proximity gestures, other proximity gestures may be suitable according to the present disclosure. For example, a non-exhaustive list of additional gestures may include, but is not limited to, single finger hover-out gestures, multi-finger hover out-gestures, single finger hover gestures, multi-finger hover gestures, multi-finger spread gestures, multi-finger pinch gestures, single finger push/pull gestures, multi-finger push/pull gestures, single finger circular gestures, multi-finger circular gestures, single finger tap gestures, multi-finger tap gestures, single finger wave gestures, multi-finger wave gestures, single finger flick gestures, multi-finger flick gestures, single finger hold-and-move gestures, multi-finger hold-and-move gestures, single finger dial gestures, multi-finger dial gestures, single finger rotate gestures, multi-finger rotate gestures, single finger orbit gestures, multi-finger orbit gestures, single finger spin gestures, multi-finger spin gestures, other types of proximity gestures, or combinations thereof.

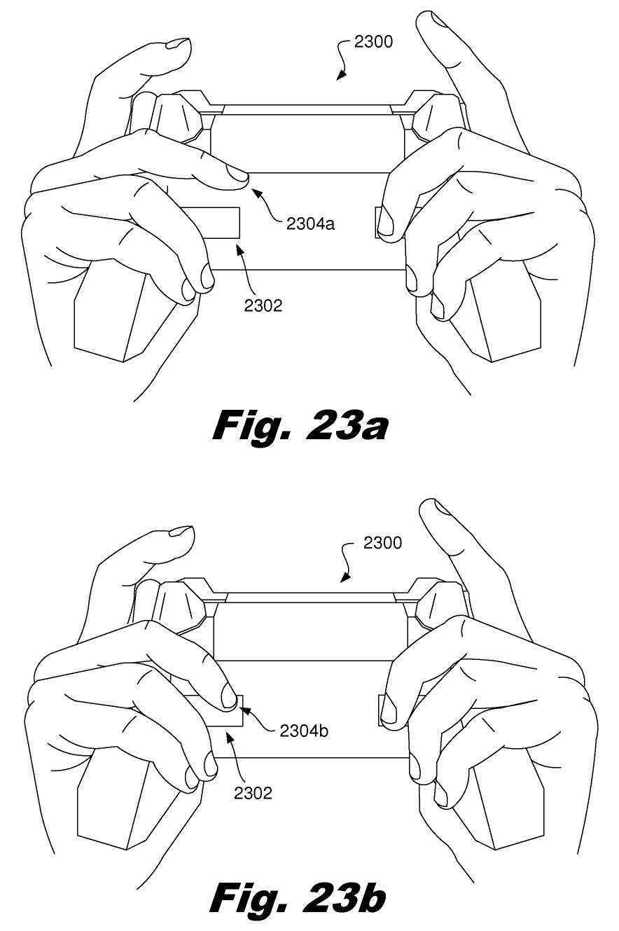

FIGS. 23a and 23b depict examples of user interaction with a gaming controller 2300 in accordance with the disclosure. Although earlier examples describe measuring and recording touch and proximity inputs in the context of a laptop device, the same principles may be applied to other electronic devices that incorporate capacitance modules. In this example, the gaming controller 2300 includes a capacitance module 2302 configured to detect proximity inputs, touch inputs, or both. As with the previously described embodiments, the attributes measured from user interaction with the gaming controller 2300 may be recorded, processed, and used for input classification, including classification performed by machine-learning models.

In the example of FIG. 23a, a user holding the gaming controller 2300 hovers a finger above the surface of the capacitance module 2302, thereby providing a proximity input 2304a. The capacitance module 2302 may detect the proximity input 2304a by measuring changes in electric field coupling as the user’s finger approaches the surface of the device and may record proximity attributes associated with the hover interaction.

In the example of FIG. 23b, the user presses their finger against the surface of the capacitance module 2302, thereby providing a touch input 2304b. As the finger makes physical contact, the capacitance module 2302 may record the touch attributes for later use in input classification.

Differentiating between proximity inputs and touch inputs may be particularly useful in a gaming controller context. In some examples, proximity inputs may serve as pre-action cues, gesture inputs, or hover-based controls that allow a game to detect a player’s intended action before physical contact is made. In some examples, touch inputs may represent deliberate selections, button activations, or confirmatory actions. By reliably distinguishing between these input types, a gaming controller may enable more responsive gameplay, reduce accidental activations, and provide additional input channels without the need for additional physical buttons or sensors.

In some examples, proximity inputs detected through a capacitance module may also be used in virtual reality (VR) or augmented reality (AR) controller systems to track hand posture, finger movement, or gesture intent. For instance, subtle hover movements over the capacitance module 2302 may be used to infer finger motion trajectories or to approximate hand configurations, enabling richer interaction models without relying solely on optical tracking. Recording proximity attributes in these contexts may enhance machine-learning-based classification, improve gesture recognition accuracy, and enable more natural and expressive user interactions across gaming, VR, and AR applications.

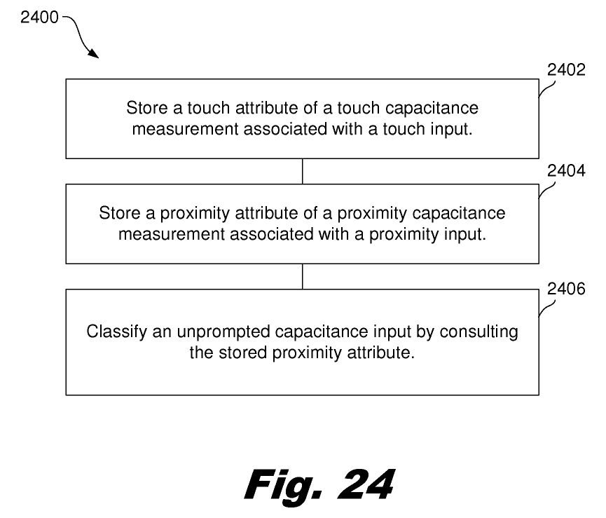

FIG. 24 depicts an example of a method 2400 for classifying an unprompted input. This method 2400 may be performed based on the description of the devices, modules, and principles described in relation to FIGS. 1-23b. In this example, the method 2400 includes storing 2402 a touch attribute of a touch capacitance measurement associated with a touch input, storing 2404 a proximity attribute of a proximity capacitance measurement associated with a proximity input, and classifying 2406 an unprompted capacitance input by consulting the stored proximity attribute.

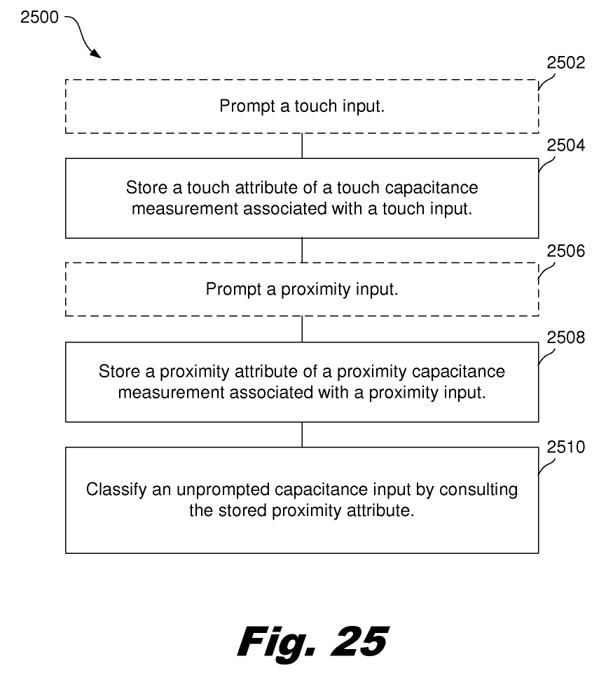

FIG. 25 depicts an example of a method 2500 for classifying an unprompted input. This method 2500 may be performed based on the description of the devices, modules, and principles described in relation to FIGS. 1-23b. In this example, the method 2500 includes optionally prompting 2502 a touch input, storing 2504 a touch attribute of a touch capacitance measurement associated with a touch input, optionally prompting 2506 a proximity input, storing 2508 a proximity attribute of a proximity capacitance measurement associated with a proximity input, and classifying 2510 an unprompted capacitance input by consulting the stored proximity attribute.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A capacitance module, comprising:
a set of electrodes;
a controller in communication with the set of electrodes;
memory in communication with the controller;
wherein the memory includes programmed instructions that cause the controller, when executed, to:
store a touch attribute of a touch capacitance measurement associated with a touch input;
store a proximity attribute of a proximity capacitance measurement associated with a proximity input; and
update a proximity attribute based on an unprompted capacitance measurement.

2. The capacitance module of claim 1, the programmed instructions cause the controller, when executed, to prompt a touch input.

3. The capacitance module of claim 1, the programmed instructions cause the controller, when executed, to prompt a proximity input.

4. The capacitance module of claim 1, the programmed instructions cause the controller, when executed, to store a noise attribute associated with a noise input.

5. The capacitance module of claim 4, the programmed instructions cause the controller, when executed, to:
prompt the noise input; and
store the noise attribute of a capacitance measurement associated with the noise input.

6. The capacitance module of claim 1, wherein the proximity attribute is associated with a single finger gesture.

7. The capacitance module of claim 1, wherein the proximity attribute is associated with a two-finger gesture.

8. The capacitance module of claim 1, wherein the proximity attribute is associated with a three-finger gesture.

9. The capacitance module of claim 1, wherein the proximity attribute comprises at least one of a minimum detectable proximity distance, a proximity slope, and a proximity decay rate.

10. The capacitance module of claim 1, the programmed instructions cause the controller, when executed, to classify an unprompted input by consulting at least one of the stored touch attribute and stored proximity attribute.

11. The capacitance module of claim 10, wherein classifying the unprompted input includes classifying the unprompted input as a touch input.

12. The capacitance module of claim 10, wherein classifying the unprompted input includes classifying the unprompted input as a proximity input.

13. The capacitance module of claim 10, wherein classifying the unprompted input includes classifying the unprompted input as a one finger proximity input.

14. The capacitance module of claim 10, wherein classifying the unprompted input includes classifying the unprompted input as a two-finger proximity input.

15. The capacitance module of claim 10, wherein classifying the unprompted input includes classifying the unprompted input as a three-finger proximity input.

16. The capacitance module of claim 1, the programmed instructions cause the controller, when executed, to:
create the touch attribute using a touch machine learning model;
train the touch machine learning model with multiple touch inputs;
create the proximity attribute using a proximity machine learning model; and
train the proximity machine learning model with multiple proximity inputs.

17. The capacitance module of claim 16, wherein training the touch machine learning model and proximity machine learning model includes unsupervised learning.

18. A computer-program product for determining a proximity input on a capacitance module; the computer-program product comprising a non-transitory computer-readable medium storing instructions executable by a controller to:
store a touch attribute of a touch capacitance measurement associated with a touch input;
store a proximity attribute of a proximity capacitance measurement associated with a proximity input; and
classify an unprompted capacitance input by consulting the stored proximity attribute.

19. The computer-program product of claim 18, the programmed instructions cause, when executed, the controller to:
prompt a touch input; and
prompt a proximity input.

20. The computer-program product of claim 18, the programmed instructions cause, when executed, the controller to:
train a touch machine learning model with at least the touch attribute; and
train a proximity machine learning model with at least the proximity attribute;
wherein classifying an unprompted capacitance input includes consulting the output of the touch machine learning model and the proximity machine learning model.
